(19) United States
(12) Patent Application Publication
(10) Pub. No.: US 2005/0118441 A1
(43) Pub. Date: Jun. 2, 2005

(54) Automobile chassis members having high surface hardness and high corrosion resistance

(75) Inventors: Motohiro Tenmaya, Tokyo (JP); Eiji Hirai, Tokyo (JP); Yutaka Sawano, Tokyo (JP); Tetsuya Yamamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nihon Parkerizing Co., Ltd., Tokyo (JP)

(21) Appl. No.: 10/969,063

(22) Filed: Oct. 21, 2004

(30) Foreign Application Priority Data
Oct. 22, 2003 (JP) JP 2003-362359

(51) Int. Cl. B32B 15/04

(52) U.S. Cl. 428/469

(57) ABSTRACT

An automobile chassis member includes a lithium-iron composite oxide layer as its outermost surface and a surface-modifying layer formed immediately below the lithium-iron composite oxide layer. The surface modifying layer contains as a surface-modifying diffusion element at least nitrogen element bonded with another element in a base material of the automobile chassis member or diffused in the base material. The lithium-iron composite oxide layer is deposited in an amount of from 10 to 1,500 mg/m² in terms of lithium atoms.

### FIELD OF THE INVENTION

This invention relates to iron-based members including those useful as materials for parts, such as steel sheets and plates and round bars, and more specifically to a technique for providing automobile chassis members with both of good mechanical properties, such as high abrasion resistance, and high corrosion resistance under corrosive environments of corrosive factors, especially such as salt.

### DESCRIPTION OF THE BACKGROUND

Automobile chassis members are primarily arranged in a state exposed to the exterior under the floor of an automobile so that they are exposed to extremely severe corrosive environments. Especially in snowy regions where snow-melting salt is sprinkled on the roads or in seashore areas, splashed or scattered salt directly adhere automobile chassis members. In other regions or areas, small stones and gravel flipped off during driving may hit such automobile members to cause surface damages and, even when coating or the like has been applied, the metals may be exposed. In the case of general structure materials, it is possible to prolong their service life to certain extent by applying heavy-duty coatings, for example, by applying flexible coatings of large thickness to them. Many of such coating measures cannot, however, be used for sliding members and the like because these metal members slide against each other. Moreover, such sliding members are required to have corrosion resistance while retaining their inherent properties or functions, that is, abrasion resistance and low friction coefficient.

Described specifically, automobile chassis members, especially automobile chassis members which undergo sliding movements are required to be equipped with both of sliding characteristics such as abrasion resistance and low friction coefficient and corrosion resistance. Steel materials are generally used these members because high structural strength is needed for them. To impart such characteristics and properties, surface treatment or surface modification processes such as chromium plating and heat-treatment hardening are applied to the steel materials. Among these techniques, hard chromium plating is applied widely as an effective treatment process irrespective of the field. Hard chromium plating is, however, accompanied by a few problems as will be described hereinafter.

One of such problems is the use of hexavalent chromium. In recent years, great important is attached to environmental issues, and restrictions are imposed on the use of chemicals which may potentially give adverse effects to the human body not only in the natural environment but also in the domestic environment. Replacement techniques from hexavalent chromium to trivalent chromium are, therefore, adopted to cope with this move. However, these replacement techniques are inferior in productivity and economy, for example, as very scrupulous care is required for the control of treatment solutions.

Another problem is concerned with anti-corrosive performance. Hard chromium plating is generally considered to be a treatment for applying high corrosion resistance. Any attempt to apply hard chromium plating to a large thickness, however, leads to a failure in bringing about anti-corrosive performance to any expected level due to the development for cracks in the plating layer. In practice, to a member which requires such treatment, nickel plating and copper plating are hence applied as multiple layers and hard chromium plating is applied over the multiple layers to impart corrosion resistance. High corrosion resistance is, therefore, not imparted by a single layer of hard chromium plating. As a corollary to this, the hard chromium plating process obviously results in high cost.

Hard chromium plating is generally formed by electrolytic treatment, so that plating of relatively uniform thickness can be applied to simple-profile parts but not to complex-profile parts. Even in the case of a simple-profile part, however, the current density must be controlled within a predetermined range at each of various positions of the to-be-treated part in order to inhibit thickening of the plating at edge portions of the part. This requires very careful attention to the setting of the part, and obviously results in low productivity.

As described in the above, hard chromium plating is not absolutely the most suitable treatment in productivity, economy and environmental issues although it is widely applied to members which require abrasion resistance and corrosion resistance. On the other hand, carbonitriding treatment (nitriding treatment, soft nitriding treatment), which is one of heat-treatment hardening processes, is effective for improving abrasion resistance from the standpoint of productivity and economy. With the surface conditions as obtained by carbonitriding treatment, however, corrosion resistance cannot be brought about to such a level as expected or desired.

For the improvement of the corrosion resistance of an iron-based member which has been subjected to nitriding treatment, treatment processes involving the application of oxidation treatment after nitriding treatment are disclosed in JP-A-56-033473 and JP-A-07-224388. It is also proposed in JP-A-05-263214 and JP-A-05-195194 to apply oxidation treatment after nitriding treatment and then to conduct wax impregnation or to apply polymer coating. These processes can bring about another advantageous effect that the coefficient of friction is reduced owing to the wax impregnation or polymer coating.

Further, JP-A-07-062522 discloses a treatment process, which upon performing nitriding treatment in a nitriding salt bath, conducts anode electrolysis to concurrently form an oxide layer on a nitride layer. This treatment process is a technique which makes it possible to perform the two-step treatment of nitriding treatment and oxidization treatment, which is proposed in JP-A-07-224388, etc., in a single step, and therefore, was expected to bring about advantageous effects in both productivity and economy.

In JP-A-2002-226963 and JP-A-2002-091906, on the other hand, soft nitriding treatment and oxidation treatment are conducted at the same time only in the conventional nitriding treatment step so that abrasion resistance and corrosion resistance are both imparted in the single step. This treatment was, therefore, expected to bring about further advantageous effects in productivity and economy.

By the treatment proposed in JP-A-56-033473 or JP-A-07-224388, the anti-corrosive performance can be significantly improved compared with the application of nitriding treatment, but the thus-improved anti-corrosive performance is not stable. Even when stabilization is attempted by wax impregnation as proposed in JP-A-05-263214 or JP-A-05-195194, the pores formed during the nitriding treatment cannot be completely sealed or covered so that the adoption of the treatment process proposed in JP-A-56-033473 or JP-A-07-224388 has been shelved in some instances from the viewpoint of quality control.

With the technique disclosed in JP-A-07-062522, electrolytic treatment is conducted in a nitriding salt bath so that at the time of the cathodic reaction, cyanic acid is reduced to form cyan. This has raised the problem that the concentration of cyan in the treatment bath becomes high. In addition, the current density has to be controlled within a predetermined range at each of various positions of each member during its treatment. Accordingly, very careful attention is needed to the arrangement of an opposing electrode and the setting of the member, and moreover, it is difficult to apply the treatment evenly to complex-profile members. A considerably limitation is, therefore, imposed on the range of members which can be treated by this technique.

Since accuracy in surface roughness is also required for those undergoing sliding movements among automobile chassis members, it has also been attempted to improve the accuracy by conducting polishing subsequent to the oxidation treatment in the above-described improved processes. However, the oxide film formed by the oxidation treatment is a thin film, and a majority of the thin film is removed in a polishing step. As a consequence, corrosion resistance cannot be imparted to such a high level as expected. With a view to coping with this problem, measures were taken to make the time of oxidation treatment longer or to conduct oxidation treatment again after the polishing step was performed. However, the resulting thickening of the oxide film caused insufficient accuracy, leading to high cost. The adoption of this approach has been shelved in some instances accordingly.

By procedure disclosed in JP-A-2002-226963 or JP-A-2004-091906, on the other hand, the anti-corrosive performance was significantly improved and the thus-improved anti-corrosive performance was stable compared the conventional processes, as described in JP-A-2003-027211. Nonetheless, when the treatment was applied to actual parts and they was improved in dimensional accuracy by post-grinding, post-polishing or the like, very stable, high corrosion resistance was not available in some instances.

### SUMMARY OF THE INVENTION

To resolve the above-described problems, the present inventors have proceeded with a further extensive investigation on the technique disclosed in JP-A-2003-027211. As a result, it has been found that still better anti-corrosive performance can be exhibited by controlling the quantity of lithium atoms in a lithium-iron composite oxide layer, leading to the completion of the present invention.

In one aspect of the present invention, there is thus provided an automobile chassis member comprising a lithium-iron composite oxide layer (hereinafter simply called “composite oxide layer” for the sake of brevity) as an outermost surface of the automobile chassis member, and a surface-modifying layer (hereinafter called “soft nitrided layer”) formed immediately below the composite oxide layer and containing as a surface-modifying diffusion element at least nitrogen element bonded with another element in a base material of the automobile chassis member or diffused in the base material. The composite oxide layer is deposited in an amount of from 10 to 1,500 mg/m² in terms of lithium atoms.

Mutually adjacent portions of the composite oxide layer and the soft nitrided layer may exist as a mixture layer between the remaining portions of the composite oxide layer and the soft nitrided layer. The base material may be a steel material other than at least stainless steel and free-cutting lead steel, and the steel material has an iron content of at least 90 wt. %. The composite oxide layer may comprise a composite oxide represented by Li₅Fe₅O₈ and formed therein. The composite oxide layer may have a thickness of from 0.1 to 7 μm. The soft nitrided layer may have a thickness of from 2 to 20 μm. The member may preferably have a surface roughness of not greater than 2.0 μm in terms of Rz. Further, the automobile chassis member may be provided with a surface finished by finish machining such as grinding finish, buffing finish, vibratory barrel finish or shot blasting.

According to the present invention as described above, an automobile chassis member, which has a composite oxide layer and soft nitrided layer formed in adjacent to a surface thereof and is used under corrosive environments such as splashed or scattered salt, can exhibit very high anti-corrosive performance by controlling the quantity of lithium atoms deposited in the composite oxide layer. The present invention, therefore, can make a significant contribution to the improvements of automobile chassis members which require abrasion resistance and corrosion resistance.

### BRIEF DESCRIPTION OF THE DRAWINGS

FIG. 1 is a schematic diagram of a cross-section structure of an automobile chassis member according to the present invention at and adjacent a surface thereof.

FIG. 2A is a schematic illustration of a friction wear test by a Falex friction wear testing machine, and shows a pin rotating between two vee blocks for the Falex test.

FIG. 2B is a simplified perspective view of one of the vee blocks of FIG. 2A for the Falex test.

### DETAILED DESCRIPTION OF THE PREFERRED EMBODIMENTS

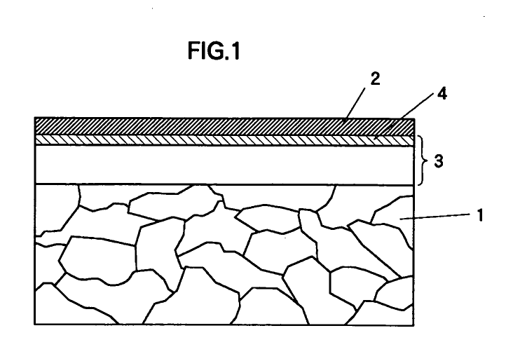

A description will next be made about certain preferred embodiments of the present invention. Reference will firstly be had to FIG. 1. As illustrated in the figure, an automobile chassis member according to the present invention has a composite oxide layer 2 as an outermost surface of a base material 1 as a base material to be treated. Immediately below the composite oxide layer 2, that is, between the composite oxide layer 2 and the base material 1, a soft nitride layer 3 is formed. In a preferred embodiment, the soft nitride layer 3 is formed in a porous form at the surface thereof, and the composite oxide layer 2 is formed in a state plugged into the pores of the surface porous layer of the soft nitride layer 3. Between the composite oxide layer 2 and the soft nitride layer 3, a mixture layer 4 of the composite oxide and the soft nitride is formed. The present invention is characterized in that in the automobile chassis member of the above-described construction, the amount of the composite oxide layer 2 so deposited or the total amount of the composite oxide layer 2 and mixture layer 4 so deposited is from 10 to 1,500 mg/m² in terms of lithium atoms.

No particular limitation is imposed on the base material (the base material to be treated) which makes up the member according to the present invention, insofar as it is an iron-based material. When the base material is stainless steel, however, it may very occasionally be impossible to make a compensation for a reduction in the corrosion resistance of the member due to the formation of chromium nitrides during the surface treatment of the base material because of the existence of chromium in the stainless steel. When the base material is free-cutting lead steel, on the other hand, the formation of the lithium-iron composite oxide (hereinafter referred to as the “composite oxide” for the sake of brevity) is inhibited under the influence of the lead contained in the base material, so that a higher treatment temperature or longer treatment time is required. As a result, the productivity is lowered, leading to a higher economical load. In addition, the formation of the composite oxide layer may also be inhibited when the content of iron in the base material is low. Accordingly, the base material can preferably be such a steel material that it is other than at least stainless steel and free-cutting lead steel and has an iron content of 90 wt. % or higher.

No particular limitation is imposed on a process for forming the composite oxide layer 2 and soft nitride layer 3 (and mixture layer 4) on the surface of the base material 1, insofar as the amount of the composite oxide layer 2 so deposited or, if there is the mixture layer 4, the total amount of the composite oxide layer 2 and mixture layer 4 so deposited falls within the range of from 10 to 1,500 mg/m² in terms of lithium atoms. Conventionally-known processes such as that disclosed in JP-A-2002-226963 or the like can be relied upon, although the process disclosed in JP-A-2004-091906 can be mentioned as a preferred example. Specifically, the above-described base material is immersed in a nitriding base bath containing Li⁺, Na⁺ and K⁺ as cationic components along with CNO⁻ and CO₃⁻⁻ as anionic components, so that the soft nitride layer 3 is formed on the surface of the base material. According to the process disclosed in JP-A-2004-091906, the oxidation power of the nitriding salt bath is enhanced by adding an oxidation power enhancer, which is selected from the group consisting of alkali hydroxides, bound water, free water and damp air, to the nitriding salt bath such that concurrently with the formation of the soft nitride layer 3 on the surface of the base material, the composite oxide layer 2 is formed as an outermost surface. In this process, it is preferred to immerse, in a step subsequent to the above-described immersion in the nitriding salt bath, the treated base material in a replacement washing salt bath with an alkali metal nitrate contained therein. For details, reference may be had to JP-A-2004-091906.

The automobile chassis member according to the present invention requires that upon forming the composite oxide layer 2 and the soft nitride layer 3 (and the mixture layer 4) in the above-described nitriding salt bath, the thickness (deposited amount) of the composite oxide layer 2 or the total thickness (deposited amount) of the composite oxide layer 2 and mixture layer 4, specifically the quantity of lithium atoms per unit area when the amount or total amount is expressed in terms of lithium atoms falls within the range of from 10 to 1,500 mg/m², more preferably from 50 to 1,500 mg/m², still more preferably from 100 to 1,000 mg/m². A quantity of lithium atoms smaller than 10 mg/m² cannot achieve the object of the present invention, while a quantity of lithium atoms greater than 1,500 mg/m² results in the formation of the composite oxide layer 2 with an excessively large thickness and as a consequence, induces coarsening of the crystalline particles making up the composite oxide layer 2, and therefore, involves a potential problem in that such an excessively large quantity of lithium atoms may conversely provide the resulting treated member with reduced corrosion resistance. It is to be noted that the deposited quantity of lithium atoms per unit area, in other words, the thickness of the composite oxide layer 2 can be adjusted by finish machining such as post-grinding, buffing or shot blasting.

The thickness of the composite oxide layer 2 may preferably be set at from 0.1 to 7 μm. To form a composite oxide layer 2 made of denser crystals, a range of from 1 to 5 μm is more preferred, with a range of from 2 to 4 μm being still more preferred. The thickness of the composite oxide layer 2 can be determined by controlling the treatment temperature and treatment time of the salt-bath nitriding treatment. A thickness of the composite oxide layer 2 smaller than 0.1 μm cannot achieve the object of the present invention, while a thickness of the composite oxide layer 2 greater than 7 μm may result in the induction of coarsening of the crystalline particles making up the composite oxide layer 2, thereby developing such a potential problem that the resulting member may conversely provided with reduced corrosion resistance.

It is also preferred that a lithium-iron composite oxide represented by Li₅Fe₅O₈ is identified in the composite oxide layer 2. If not identified, the resultant member may be inferior in anti-corrosive performance.

By the salt-bath nitriding of the base material, the soft nitride layer 3 is concurrently formed immediately below the composite oxide layer 2. However, no sufficient advantageous effect can be observed on the anti-corrosive performance of the resulting, surface-treated member if the thickness of the soft nitride layer 3 is small. Also taking both productivity and economy into consideration, the thickness of the soft nitride layer 3 may be preferably from 2 to 20 μm, more preferably from 4 to 15 μm, still more preferably from 6 to 12 μm.

Concerning the structure of the soft nitride layer 3, the soft nitride layer 3 may preferably have a porous structure because the composite oxide can still remain in the pores even when the composite oxide layer 2 as the outermost surface is removed upon sliding movement of the member according to the present invention. The high anti-corrosive performance of the surface-treated member can, therefore, be retained even when the composite oxide layer 2 is removed. It is, therefore, still more preferred that an upper layer portion of the soft nitride layer 3 has a porous structure and the composite oxide is mixed in the porous layer portion (in other words, the mixture layer 4 of the composite oxide and the soft nitride exists).

Turning next to the surface roughness of the surface-treated member so obtained, the existence of large asperities on the surface induces an increase in the coefficient of friction upon sliding movements, resulting in a reduction in anti-abrasion performance. Even when the thickness control of the composite oxide layer is not effected by finish machining such as surface grinding or polishing, buffing or shot blasting, the surface roughness can desirably be 2.0 μm or smaller, with 1.5 μm or smaller being more preferred. The member subjected to surface treatment as described above may be finished by finish machining such as grinding finish, buffing finish, vibratory barrel finish or shot blasting.

As has been described in the above, the present invention has made further improvements in the technique disclosed in JP-A-2003-27211 by applying the technique disclosed in JP-A-2004-091906. In examples to be described subsequently herein, the advantageous effects of the present invention were, therefore, confirmed based on treated members which had been obtained by applying nitriding treatment to base materials in a molten salt and then immersing the thus-treated base materials in a washing salt bath. The molten salt had a composition obtained by mixing the carbonates of Na, K and Li together and then converting of those carbonates into CNO salts, and the washing salt bath contained an alkali nitrate. It is, however, to be noted that the quantity of lithium atoms deposited in the composite oxide layer principally governs the performance and therefore, that the automobile chassis member according to the present invention shall not be limited to those produce by making use of the process disclosed in JP-A-2004-091906 or JP-A-2003-027211 referred to in the above.

Members to which the present invention can be applied are called “automobile chassis members” herein. The term “automobile chassis member” as used herein means a member of an automobile which is exposed to exterior air or comes into contact with exterior air, and therefore, embraces a variety of members such as shock absorbers, drive shafts, stabilizers, brake shafts, suspension arms, suspension springs, torsion bars, trailing arms, lower arms, upper arms, anchor brackets, suspension ball joints, brake master cylinder pistons, proportioning valves, wheel caps, differential gears, axle housings, rear axle shafts, universal joints, propeller shafts, clutch hubs, clutch release forks, and so on. The present invention can also be applied to members directly exposed to rain and wind, such as wiper arms.

### EXAMPLES

A description will hereinafter be made about more specific examples of the present invention. It should, however, be borne in mind that the present invention shall by no means be limited by the following examples.

[Preparation of Specimens for the Determination of Corrosion Resistance]

### EXAMPLES

SPCC-SB material [70×150×0.8(thickness) mm] of JIS G3142 Standards was immersed at 580° C. for 60 minutes in a molten salt I, immersed at 400° C. for 10 minutes in a molten salt II, and then chilled with water to afford specimens A1. The molten salt I was prepared by mixing the carbonates of Na, K and Li together and converting portions of the mixed carbonates into their corresponding CNO⁻ salts, had the following composition: Na, 11 wt. %; K, 30 wt. %; Li, 4 wt. %; CO₃, 40 wt. %; CNO: 15 wt. %. The molten salt II, on the other hand, was prepared by mixing NaNO₂, KNO₃ and NaOH in proportions of 43 wt. %, 52 wt. % and 5 wt. %, respectively.

Specimens A2 were afforded in a similar manner as the specimens A1 except that the conditions for the immersion in the molten salt I were changed to 580° C. and 90 minutes.

SPCC-SB material of the same kind as that employed in the above was immersed at 580° C. for 240 minutes in the molten salt I, immersed at 400° C. for 10 minutes in the molten salt II, and then chilled with water. The thus-treated material was then buffed at a surface thereof to afford specimens A3.

Specimens A4 were afforded in a similar manner as the specimens A3 except that instead of buffing, the surface was polished at an air pressure of 3 Kg/mm² by glass beads of 200 mesh. Further, some of the specimens A3 were repeatedly buffed to polish their surfaces so that specimens A5 were afforded.

[Preparation of Specimens for Friction Wear Tests]

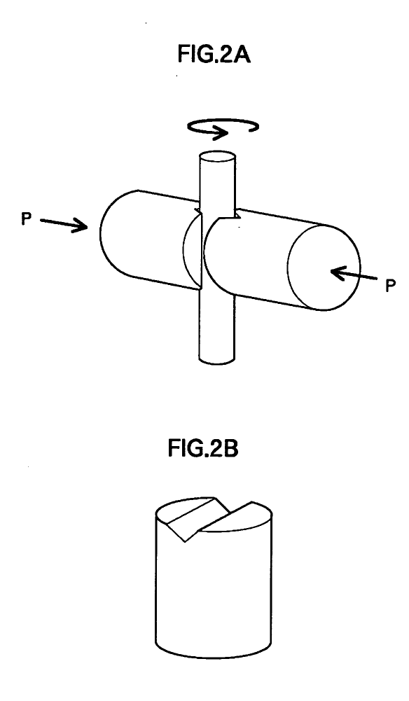

Test pins for the Falex test [refined SCM 440 material of JIS G4105 Standards, 10 mm (diameter)×35 mm)] and vee blocks for the Falex test [refined SCM 440 material of JIS G4105 Standards, cylindrical disks of 15 mm (diameter)×15 mm with a V-shaped notch of 10 mm in width, 5 mm in depth and 90 degrees in angle formed in one ends thereof; see FIG. 2B], both of which will be described subsequently herein, were immersed at 580° C. for 60 minutes in the molten salt I, immersed at 400° C. for 10 minutes in the molten salt II, and then chilled with water to afford specimens A6.

Some of the test pins and vee blocks for the Falex test were immersed at 580° C. for 60 minutes in the molten salt I, immersed at 400° C. for 10 minutes in the molten salt II, and then chilled with water. Subsequently, they were buffed to polish their surfaces so that specimens A7 were afforded.

Specimens A8 were afforded in a similar manner as the specimens A7 except that the conditions for the immersion in the molten salt I were changed to 580° C. and 240 minutes.

### Comparative Examples

[Preparation of Specimens for the Determination of Corrosion Resistance]

SPCC-SB material of the same type as employed in the above were left over for 120 minutes in a molten salt III, immersed at 580° C. for 90 minutes in the molten salt III, immersed at 400° C. for 10 minutes in the molten salt II, and then chilled with water to afford Specimens C1. The molten salt III was prepared by dissolving potassium ferrocyanide in a portion of the molten salt I to give an iron content of 1 wt. %.

Specimens C2 were obtained by applying chromium plating to SPCC-SB material of the same type as employed in the above.

[Preparation of Specimens for Friction Wear Tests]

Test pins and vee bocks for the Falex test, which were of the same types as employed in the above, were immersed at 580° C. for 60 minutes in the molten salt III, immersed at 400° C. for 10 minutes in the molten salt II, and then chilled with water to afford specimens C3.

Test pins and vee bocks for the Falex test, which were of the same types as employed in the above, were immersed at 580° C. for 240 minutes in the molten salt I, immersed at 400° C. for 10 minutes in the molten salt II, and then chilled with water to afford specimens C4.

Chromium plating was applied to test pins and vee bocks for the Falex test, which were of the same types as employed in the above, and then, the thus-plated pins and blocks were buffed at surfaces thereof to afford specimens C5.

Test pins and vee bocks for the Falex test, which were of the same types as employed in the above, were provided as specimens C6 without any treatment.

[Thickness Determination of Composite Oxide Layers and Soft Nitride Layers]

Concerning the thicknesses of composite oxide layers and soft nitride layers, photographing was conducted at ×495 photographic magnification under an optical microscope (“AHMT 3”, trade name; manufactured by OLYMPUS CORPORATION) to determine them. In the case of each specimen the soft nitride layer of which had a porous structure, the specimen was assumed to include a composite oxide layer from the outermost surface to a greatest depth where the uniform formation of the composite oxide was still observed, and a soft nitride layer was defined including the composite oxide mixed in a porous nitride layer. In this respect, reference may be had to the schematic diagram of a cross-section structure at and adjacent a surface as illustrated in FIG. 1.

In the cross-section structure of each specimen A1 at and adjacent a surface thereof, a composite oxide layer of about 2 μm thick was formed as an outermost surface, and a soft nitride layer of about 8 μm thick was formed immediately below the composite oxide layer. Further, an upper layer portion of the soft nitride layer had a porous structure.

In the cross-section structure of each specimen A2 at and adjacent a surface thereof, a composite oxide layer of about 4 μm thick was formed as an outermost surface, and a soft nitride layer of about 12 μm thickness was formed immediately below the composite oxide layer. Further, an upper layer portion of the soft nitride layer had a porous structure.

In the cross-section structure of each specimen A3 at and adjacent a surface thereof, a composite oxide layer of about 4 μm thick was formed as an outermost surface, and a soft nitride layer of about 20 μm thick was formed immediately below the composite oxide layer. Further, an upper layer portion of the soft nitride layer had a porous structure.

In the cross-section structure of each specimen A4 at and adjacent a surface thereof, a composite oxide layer of about 2 μm thick was formed as an outermost surface, and a soft nitride layer of about 20 μm thick was formed immediately below the composite oxide layer. Further, an upper layer portion of the soft nitride layer had a porous structure.

In the cross-section structure of each specimen A5 at and adjacent a surface thereof, a composite oxide layer of about 0.1 μm thick was formed as an outermost surface, and a soft nitride layer of about 18 μm thick was formed immediately below the composite oxide layer. Further, an upper layer portion of the soft nitride layer had a porous structure.

In the cross-section structure of each specimen A6 at and adjacent a surface thereof, a composite oxide layer of about 1 μm thick was formed as an outermost surface, and a soft nitride layer of about 10 μm thick was formed immediately below the composite oxide layer. At that time point, the surface hardness was 906 Hv 0.1, and the surface roughness was Ra=0.31 μm and Rz=2.0 μm.

In the cross-section structure of each specimen A7 at and adjacent a surface thereof, a composite oxide layer of about 0.5 μm thick was formed as an outermost surface, and a soft nitride layer of about 10 μm thick was formed immediately below the composite oxide layer. At that time point, the surface hardness was 890 Hv 0.1, and the surface roughness was Ra=0.15 μm and Rz=1.2 μm.

In the cross-section structure of each specimen A8 at and adjacent a surface thereof, a composite oxide layer of about 3 μm thick was formed as an outermost surface, and a soft nitride layer of about 20 μm thick was formed immediately below the composite oxide layer. At that time point, the surface hardness was 945 Hv 0.1, and the surface roughness was Ra=0.20 μm and Rz=1.4 μm.

In the cross-section structure of each specimen C1 at and adjacent a surface thereof, no composite oxide layer was observed on at outermost surface, and a soft nitride layer of about 10 μm thick was formed. Further, an upper layer portion of the soft nitride layer had a porous structure.

In the cross-section structure of each specimen C2 at and adjacent a surface thereof, chromium plating of about 15 μm thick was formed and a number of cracks were formed.

In the cross-section structure of each specimen C3 at and adjacent a surface thereof, no composite oxide layer was observed on at outermost surface, and a soft nitride layer of about 8 μm thick was formed. At that time point, the surface hardness was 880 Hv 0.1, and the surface roughness was Ra=0.23 μm and Rz=1.9 μm.

In the cross-section structure of each specimen C4 at and adjacent a surface thereof, a composite oxide layer of about 9 μm thick was formed as an outermost surface, and a soft nitride layer of about 23 μm thick was formed immediately below the composite oxide layer. At that time point, the surface hardness was 930 Hv 0.1, and the surface roughness was Ra=0.61 μm and Rz=4.0 μm.

In the cross-section structure of each specimen C5 at and adjacent a surface thereof, chromium plating of about 20 μm thick was formed and a number of cracks were formed. At that time point, the surface hardness was 946 Hv 0.1, and the surface roughness was Ra=0.18 μm and Rz=1.2 μm.

The surface hardness of each specimen C6 was 321 Hv 0.1, and the surface roughness was Ra=0.08 μm and Rz=0.9 μm.

[Determination of Surface Hardness]

For the determination of surface hardness, JIS Z2244 Standards were followed. Each specimen was polished with sand paper #2000, and the Vickers hardness of the specimen was measured at a polished area under 100 g load.

[Determination of Surface Roughness]

For the determination of surface roughness, Ra and Rz were measured based on JIS B0601:'82 Standards.

[Identification of Li₅Fe₅O_{8]}

For the identification of Li₅Fe₅O₈, the crystalline structure of each specimen was examined by an X-ray diffractometer (“MXP ^{3A}HF”, trade name; manufactured by MAC Science Co., Ltd.). With respect to Specimens A1 to A8 and Specimen C4, Li₅Fe₅O₈ was identified. It was, however, not identified in Specimens C1 and C3.

[Determination of the Deposited Quantity of Lithium Atoms]

To determine the quantities of lithium atoms deposited in the specimens afforded in the respective examples and comparative examples, specimens of the corresponding base material, i.e., SPCC-SB material or SCM 440 material—which had been treated at the same time as the specimens of the examples and comparative examples, respectively—were separately immersed in aliquots of a 10 wt. % aqueous solution of hydrochloric acid to dissolve the composite oxide in their outermost surfaces, and the concentrations of lithium atoms in the resulting solutions were individually measured by an atomic absorption spectrophotometer (“SAS 7500”, trademark; manufactured by Seiko Instruments, Inc.). As a result, it was determined that the deposited quantity of lithium atoms was equivalent to 350 mg/m² in the specimen A1, 900 mg/m² in the specimen A2, 1,000 mg/m² in the specimen A3, 400 mg/m² in the specimen A4, 100 mg/m² in the specimen A5, 250 mg/m² in the specimen A6, 150 mg/m² in the specimen A7, and 450 mg/m² in the specimen A8. It was also determined that the deposited quantity of lithium atoms was equivalent to 5 mg/m² in the specimen C1, 5 mg/m² in the specimen C3, and 1,800 mg/m² in the specimen C4.

[Determination of Anti-Corrosive Performance]

To determine the anti-corrosive performance of the specimens prepared in the above examples and comparative examples, the ranking of three specimens per each example or comparative example was performed in each of a salt spray test similar to that prescribed in JIS Z2371 and a salt exposure test. In the salt exposure test, the specimens were immersed for 2 hours in a 5 wt. % aqueous solution of NaCl while maintaining the aqueous solution at 40° C. The specimens were then pulled out of the aqueous solution, and left over outdoors for 46 hours. Taking these steps as a single cycle, the test was repeatedly performed 70 cycles.

[Friction Wear Test]

The sliding characteristics of the specimens prepared in the above examples and comparative examples were tested by a Falex friction wear testing machine. The outline of a friction wear test by the Falex friction wear testing machine is depicted in FIG. 2A. In a base oil for engine oil, a Falex specimen test pin was rotated at 382 rpm, and two Falex specimen vee blocks were pressed against the pin from opposite sides while raising the load from 0 kg to 1,000 kg maximum at a rate of 25 kg per minute. During the test, the torque value of the pin was continuously measured. In the course of the test, the torque value suddenly increased at a time point. Interpreting that seizure had taken place at that time, the load applied before the seizure was recorded as a critical load for seizure, and the test was finished.

Shown in Table 1 are the deposited quantities of lithium atoms, the results of identification of Li₅Fe₅O₈, the thicknesses of the composite oxide layers and the thicknesses of the soft nitride layers in the specimens obtained in the examples and comparative examples. The results of the anti-corrosive performance tests are shown in Table 2. In Table 2, letter “N” indicates that no rusting had taken place, while letter “R” indicates that rusting had taken place at at least one position. In connection with each of the specimens afforded for friction wear tests in the examples and comparative examples, its surface hardness, surface roughness, critical load for seizure and coefficient of friction immediately before the finish of its test are shown in Table 3.

TABLE 1

| | Deposited | | Thickness | Thickness |
|---|---|---|---|---|
| | quantity of | | of | of soft |
| | Li atoms | Identification | composite | nitride |
| Specimen | (mg/m²) | of Li₅Fe₅O₈ | oxide layer | layer (μm) |
| A1 | 350 | Identified | 2 | 8 |
| A2 | 900 | Identified | 4 | 12 |
| A3 | 1000 | Identified | 4 | 20 |
| A4 | 400 | Identified | 2 | 20 |
| A5 | 100 | Identified | 0.1 | 18 |
| A6 | 250 | Identified | 1 | 10 |
| A7 | 150 | Identified | 0.5 | 10 |
| A8 | 450 | Identified | 3 | 20 |
| C1 | 5 | Not identified | 0 | 10 |
| C2 | None | Not identified | None | 15 (Cr |
| | | | | plating) |
| C3 | 5 | Not identified | 0 | 8 |
| C4 | 1800 | Identified | 9 | 23 |
| C5 | None | Not identified | None | 20 (Cr |
| | | | | plating) |
| C6 | None | Not identified | None | None |

TABLE 2

| | Time of | | | | Salt exposure | | |
|---|---|---|---|---|---|---|---|
| | salt spray test (hr) | | | | test (cycles) | | |
| Specimen | 100 | 500 | 1000 | 1500 | 15 | 35 | 70 |
| A1 | N, N, N | N, N, N | N, N, N | N, N, N | N, N, N | N, N | N, N |
| | | | | | | N | N |
| A2 | N, N, N | N, N, N | N, N, N | N, N, N | N, N, N | N, N | N, N |
| | | | | | | N | N |
| A3 | N, N, N | N, N, N | N, N, N | N, N, N | N, N, N | N, N | N, N |
| | | | | | | N | N |
| A4 | N, N, N | N, N, N | N, N, N | N, N, N | N, N, N | N, N | N, N |
| | | | | | | N | N |
| A5 | N, N, N | N, N, N | N, N, R | N, R, R | N, N, N | N, N | N, N, |
| | | | | | | N | R |
| C1 | N, N, R | R, R, R | | | R, R, R | | |
| C2 | R, R, R | | | | R, R, R | | |

TABLE 3

| | | | Critical | Coefficient of friction |
|---|---|---|---|---|
| | Surface | Surface | load | immediately before |
| | hardness | roughness | for seizure | finish of |
| Specimen | (100 g load) | (μm) | (kg) | friction wear test |
| A6 | 906 | Ra: 0.31 | ≧1000 | 0.08 |
| | | Rz: 2.0 | | |
| A7 | 890 | Ra: 0.15 | ≧1000 | 0.05 |
| | | Rz: 1.2 | | |
| A8 | 945 | Ra: 0.20 | ≧1000 | 0.06 |
| | | Rz: 1.4 | | |
| C3 | 880 | Ra: 0.23 | 700 | 0.12 |
| | | Rz: 1.9 | | |
| C4 | 930 | Ra: 0.61 | ≧850 | 0.10 |
| | | Rz: 4.0 | | |
| C5 | 946 | Ra: 0.18 | 400 | 0.14 |
| | | Rz: 1.2 | | |
| C6 | 321 | Ra: 0.08 | 250 | 0.11 |
| | | Rz: 0.9 | | |

From the test results on anti-corrosive performance shown in Table 2, it is appreciated that no advantageous effects can be brought about for anti-corrosive performance if like the specimen C1, the composite oxide is not formed and the deposited quantity of lithium atoms is insufficient, and also that the specimen A5 showed anti-corrosive performance far better than that available from the technique disclosed in JP-A-2003-027211 owing to the formation of the composite oxide in an amount enough to deposit lithium atoms in a sufficient quantity in the soft nitride layer although the complex oxide in the outermost surface had been removed by buffing.

From Table 3, it is appreciated from a comparison in critical load for seizure between the specimens of the examples and the non-treated material (the specimen C6) that the specimens of the examples were significantly improved in anti-seizure performance. As indicated by the specimen A6, it is also appreciated that, insofar as the surface roughness is 2.0 μm or smaller in terms of Rz, the adequate control of the deposited quantity of lithium atoms makes it possible to show improved performance over the specimen C3 of similar surface roughness even if the surface is not subjected to grinding fish. Further, it is also appreciated that the specimen A6 showed similar anti-seizure performance as the specimens A7 and A8 lowered in surface roughness by buffing and did not develop seizure even when the load was applied up to 1,000 kg, and also that immediately before the finish of the test under 1,000 kg load, the specimen showed a low coefficient of friction not greater than 0.1.

It is also appreciated from Table 3 that the specimen C4, on the other hand, developed seizure under a lower load than the specimens A6 to A8. It is presumed that, because the composite oxide layer formed as the outermost surface was thick, the coarsening of crystals was induced and as a result, the composite oxide fell off prematurely during the initial stage of sliding movements or worn-off particles damaged the sliding surface.

According to the present invention, it is possible to providing automobile chassis members with both of good mechanical properties, such as high abrasion resistance, and high corrosion resistance under corrosive environments of corrosive factors, especially such as salt.

This application claims the priority of Japanese Patent Application 2003-362357 filed Oct. 22, 2003, which is incorporated herein by reference.

1. An automobile chassis member comprising:
a lithium-iron composite oxide layer as an outermost surface of said automobile chassis member, and
a surface-modifying layer formed immediately below said lithium-iron composite oxide layer and containing as a surface-modifying diffusion element at least nitrogen element bonded with another element in a base material of said automobile chassis member or diffused in said base material,
wherein said lithium-iron composite oxide layer is deposited in an amount of from 10 to 1,500 mg/m² in terms of lithium atoms.

2. An automobile chassis member according to claim 1, wherein mutually adjacent portions of said lithium-iron composite oxide layer and said surface modifying layer exist as a mixture layer between the remaining portions of said lithium-iron composite oxide layer and said surface modifying layer.

3. An automobile chassis member according to claim 2, wherein said lithium-iron composite oxide layer comprises a lithium-iron composite oxide represented by Li₅Fe₅O₈ and formed therein.

4. An automobile chassis member according to claim 1, wherein said base material is a steel material other than at least stainless steel and free-cutting lead steel, and said steel material has an iron content of at least 90 wt. %.

5. An automobile chassis member according to claim 1, wherein said lithium-iron composite oxide layer comprises a lithium-iron composite oxide represented by Li₅Fe₅O₈ and formed therein.

6. An automobile chassis member according to claim 1, wherein said lithium-iron composite oxide layer has a thickness of from 0.1 to 7 μm.

7. An automobile chassis member according to claim 1, wherein said surface-modifying layer has a thickness of from 2 to 20 μm.

8. An automobile chassis member according to claim 1, wherein said member has a surface roughness of not greater than 2.0 μm in terms of Rz.

9. An automobile chassis member according to claim 1, wherein said automobile chassis member is provided with a surface finished by finish machining.

10. An automobile chassis member according to claim 9, wherein said finish machining is selected from the group consisting of grinding finish, buffing finish, vibratory barrel finish and shot blasting.
